(19) United States
(12) Patent Application Publication
(10) Pub. No.: US 2016/0280981 A1
(43) Pub. Date: Sep. 29, 2016

(54) COMPOSITIONS AND METHODS FOR WELL CEMENTING

(71) Applicant: Schlumberger Technology Corporation, Sugar Land, TX (US)

(72) Inventors: Samuel Danican, Sugar Land, TX (US); Jesse Lee, Sugar Land, TX (US)

(21) Appl. No.: 14/667,289

(22) Filed: Mar. 24, 2015

(51) Int. Cl. C09K 8/46; E21B 33/138

(52) U.S. Cl. CPC C09K 8/46; E21B 33/138

(57) ABSTRACT

Cement slurries are prepared that comprise water and a blend comprising an inorganic cement and particles with a sphericity between 0.5 and 0.9 and a Krumbein roundness between 0.5 and 0.9. The particles may comprise elastomers that impart flexibility to the set cement. The particles may be present at concentrations between 5% and 45% by volume of the slurry.

### BACKGROUND

The statements in this section merely provide background information related to the present disclosure and may not constitute prior art.

This disclosure relates to compositions and methods for serving subterranean wells, in particular, cement systems that possess improved mechanical properties and lower permeability, and methods by which they are applied as cements in both primary and remedial cementing operations.

Primary cementing in a cased oil, gas, or water well is the process of placing cement in the annulus between the casing and the formations through which the wellbore passes, or between two casing strings. One of the major objectives is to provide zonal isolation, which is the prevention of fluid flow between different formation layers. Good bonding between set cement and casing and between set cement and the formation is essential for effective zonal isolation. Poor bonding limits production and reduces the effectiveness of stimulation treatments.

Bonding and zonal isolation may be adversely affected by various events that may occur during the life of a well. Expansion or contraction of the casing may result from pressure fluctuations during stimulation operations, or temperature changes owing to cement hydration or the pumping of fluids into or out of the well. Mechanical disturbances resulting from various well intervention operations or tectonic movement may also have negative consequences with regard to cement sheath integrity.

To counteract the vulnerability of cement sheath to the hazards discussed above, the industry has developed cement systems that have improved flexibility, tensile strength or toughness or a combination thereof. Many of the improved cement systems may contain flexible additives, including elastomer particles. Other cements may contain fibers that may provide mechanical reinforcement. Yet other cements may be foamed to improve flexibility.

### SUMMARY

The present disclosure describes improved flexible cement compositions and methods for applying them in subterranean wells.

In an aspect, embodiments relate to compositions comprising water, an inorganic cement and particles with a Krumbein roundness between 0.5 and 0.9.

In a further aspect, embodiments relate to methods for preparing a cement slurry. A composition is prepared that comprises water, an inorganic cement and particles with a Krumbein roundness between 0.5 and 0.9. The composition is sheared until it is homogeneous, thereby forming a slurry.

In yet a further aspect, embodiments relate to methods for cementing a subterranean well. A composition is prepared that comprises water, an inorganic cement and particles with a Krumbein roundness between 0.5 and 0.9. The composition is sheared until it is homogeneous, thereby forming a slurry. The slurry is then placed in the well.

### BRIEF DESCRIPTION OF THE DRAWINGS

FIG. 1 is a chart for estimating the sphericity and roundness of particles.

FIGS. 2A and 2B are photographs of two types of polypropylene particles.

FIG. 3 is a graph showing the particle-size distributions of two types of polypropylene particles.

### DETAILED DESCRIPTION

The present disclosure will be described in terms of treatment of vertical wells, but is equally applicable to wells of any orientation. The disclosure will be described for hydrocarbon-production wells, but it is to be understood that the disclosed methods can be used for wells for the production of other fluids, such as water or carbon dioxide, or, for example, for injection or storage wells. It should also be understood that throughout this specification, when a concentration or amount range is described as being useful, or suitable, or the like, it is intended that any and every concentration or amount within the range, including the end points, is to be considered as having been stated. Furthermore, each numerical value should be read once as modified by the term “about” (unless already expressly so modified) and then read again as not to be so modified unless otherwise stated in context. For example, “a range of from 1 to 10” is to be read as indicating each and every possible number along the continuum between about 1 and about 10. In other words, when a certain range is expressed, even if only a few specific data points are explicitly identified or referred to within the range, or even when no data points are referred to within the range, it is to be understood that the Applicants appreciate and understand that any and all data points within the range are to be considered to have been specified, and that the Applicants have possession of the entire range and all points within the range.

In this disclosure, the tubular body may be any string of tubulars that may be run into the wellbore and at least partially cemented in place. Examples include casing, liner, solid expandable tubular, production tubing and drill pipe.

An example of a flexible cement system is FlexSTONE™ technology, available from Schlumberger. FlexSTONE cements contain elastomeric particles at concentrations such that the particles occupy a significant volume of the set cement matrix. The particles may be considered to be part of the porosity of the cement matrix because they are largely inert and may contribute little to the strength of the set cement. The role of the particles includes increasing the solid volume fraction (SVF) of the cement slurry in order to decrease the permeability of the set cement. Set cements with low permeability (e.g., <0.1 mD) may be better suited to provide and maintain zonal isolation in the well.

FlexSTONE™ cements are an example of an engineered particle size cement system. The cement blend is composed of coarse, medium-size and fine particles. The coarse particles may be present at a concentration of 55% by volume of blend (BVOB), medium-size particles at a concentration of 35% BVOB and fine particles at a concentration of 10% BVOB. The solid volume fraction (SVF) of such cement slurries may be between 0.55 and 0.60. The particle sizes may be chosen such that the medium-size particles fit within the interstices between the coarse particles, and the fine particles fit within the interstices between the medium-size particles.

Improved set cement flexibility may also be achieved by increasing the water concentration; however, the permeability of the resulting set cement may be too high, particularly if the bottomhole temperature exceeds 110° C.

Suitable elastomeric particles include ground rubber tires and polypropylene. Such particles are hydrophobic and may in some cases be difficult to incorporate into cement slurries during mixing operations with standard field equipment.

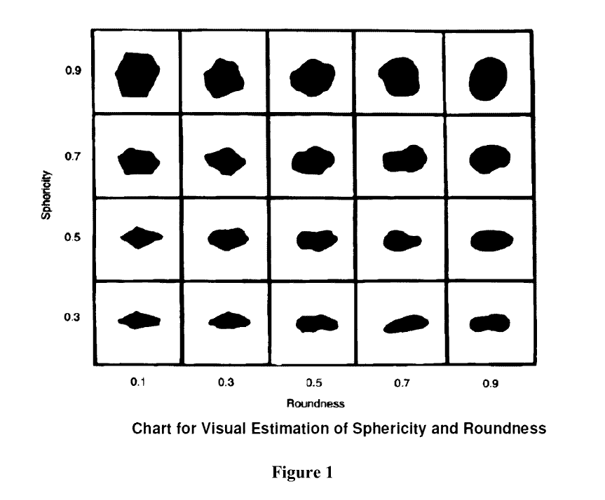

Applicant has determined that it is possible to improve the mixability and rheological properties of flexible slurries by adjusting the morphology and particle-size distribution of the elastomeric particles. Increasing the flexible particle sphericity and minimizing the amount of particles with sizes smaller than 200 microns leads to favorable results. The improved flexible particles have a sphericity and Krumbein roundness between 0.5 and 0.9. The Krumbein chart for estimating sphericity and roundness is presented in FIG. 1.

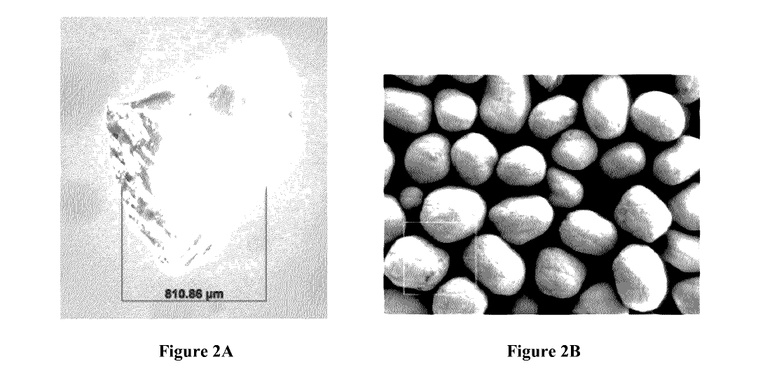

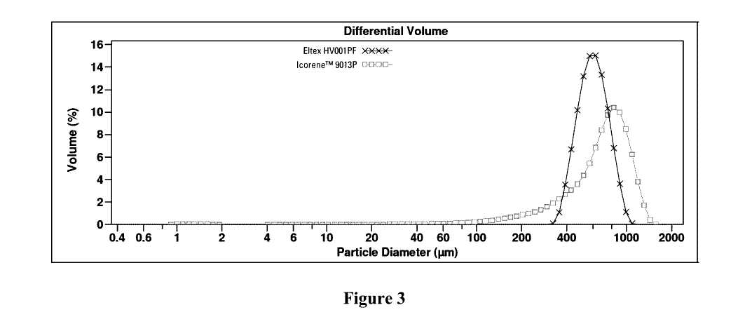

As discussed earlier, polypropylene particles may be employed to prepare flexible cement systems. One such material is Icoren™ 9013P, available from ICO Polymers. An improved polypropylene particle is Eltex P HV001PF, available from Eltex Inc. Photographs of both particles are shown in FIGS. 2A and 2B. The Icorene™ material (FIG. 2A) has a sphericity of 0.5 and a roundness of 0.1. The Eltex material (FIG. 2B) has a sphericity of 0.7 and a roundness of 0.9. The particle-size distribution of both materials are presented in Table 1 and FIG. 3. The Eltex material has a significantly narrower particle-size distribution and a smaller surface area. Most particles are in the 300-800 micron range, with few particles smaller than 200 microns. The specific gravities of both materials are equal.

TABLE 1
Particle size distributions of polypropylene particles.

| | SG | d₁₀ | d₅₀ | d₉₀ | Surface Area |
|---|---|---|---|---|---|
| Material | (g/cm³) | (microns) | (microns) | (microns) | (cm²/gram) |
| Eltex P | 0.9 | 441 | 596 | 805 | 115 |
| HV001PF | | | | | |
| D181 | 0.9 | 296 | 722 | 1076 | 252 |

In an aspect, embodiments relate to compositions comprising water, an inorganic cement and particles with a Krumbein roundness between 0.5 and 0.9.

In a further aspect, embodiments relate to methods for preparing a cement slurry. A composition is prepared that comprises water, an inorganic cement and particles with a Krumbein roundness between 0.5 and 0.9. The composition is sheared until it is homogeneous, thereby forming a slurry.

In yet a further aspect, embodiments relate to methods for cementing a subterranean well. A composition is prepared that comprises water, an inorganic cement and particles with a Krumbein roundness between 0.5 and 0.9. The composition is sheared until it is homogeneous, thereby forming a slurry. The slurry is then placed in the well. The slurry may be placed during a primary cementing or remedial cementing operation.

For all aspects, the inorganic cement may comprise portland cement, calcium aluminate cement, fly ash, blast furnace slag, lime/silica blends, cement kiln dust, zeolites, geopolymers, or chemically bonded phosphate ceramics or combinations thereof.

For all aspects, the particles may comprise polypropylene, polyethylene, polyisoprene, polybutadiene, polyisobutylene, polyurethane, polyamide, styrene butadiene, styrene divinylbenzene, acrylonitrile-butadiene, acrylonitrile-styrene-butadiene, polyetheretherketone and combination thereof. Those skilled in the art will recognize that other types of particles that meet the cited sphericity and roundness criteria may be useful in other cementing applications where efficient slurry mixing is problematic.

For all aspects, the particles may be present in the slurry at a concentration between 5% and 55% by volume, or between 10% and 35% by volume, or between 11% and 35%.

For all aspects, the particles may have an average particle size between 100 and 1000 microns, or between 100 and 500 microns, or between 150 and 500 microns. Less than 10% of the particles may be smaller than 100 microns, or less than 5% or less than 1%.

For all aspects, the slurry may further comprise particles such that the composition has a multimodal particle-size distribution.

For all aspects, the slurry viscosity may be lower than 1000 cP at a shear rate of 1000 s⁻¹.

For all aspects, the slurry may be placed during a primary cementing or a remedial cementing operations.

For all aspects, the composition may have a water-to-cement ratio between 0.7 and 1.5 by weight. The water may be fresh water, sea water or waters to which salts have been added at concentrations up to saturation.

For both aspects, the set cement may have a Young's modulus between 1.0 GPa and 6.0 GPa, or between 2.0 GPa and 4.0 GPa.

At concentrations exceeding about 5% BVOB, the presence of microsilica or silica fume may prevent particle sedimentation. Further, the microsilica or silica fume may react with calcium hydroxide to form additional calcium silicate hydrate. This pozzolanic reaction may further reduce the permeability of the set cement. Yet further, the microsilica or silica fume may enhance fluid-loss control during slurry placement.

As for conventional portland cement slurries, 35% to 40% by weight of cement (BWOC) silica flour may be added to prevent the formation of alpha dicalcium silicate hydrate if the cement is cured at temperatures exceeding 110° C. Formation of this mineral is known in the art to reduce strength and increase permeability. The additional silica promotes the formation of the mineral tobermorite (11 Å) at temperatures up to about 170° C., and the mineral xonotlite at temperatures up to at least 350° C. Tobermorite (11 Å) and xonotlite are known in the art to be associated with higher strength and lower permeability. Microsilica and silica fume may also be used for this purpose.

For all aspects, the set cement may have a permeability to water that is lower than 0.1 mD.

For all aspects, the slurry may have a density that is between 1200 kg/m³ and 2400 kg/m³. The density may be varied by selecting an appropriate mineral or blend of minerals.

For all aspects, the slurry may be substantially free of foam.

For all aspects, the cement slurry may further comprise accelerators, retarders, dispersants, fluid-loss additives, anti-settling agents, gas migration prevention agents, expansion agents, anti-gelling agents or antifoam agents or combinations thereof. The slurry may also be substantially free of hydrophobic particles.

### EXAMPLES

The following example is provided to more fully illustrate the disclosure. This example is not intended to limit the scope of the disclosure in any way.

The experiments described below were performed in accordance with recommended procedures published by the American Petroleum Institute (API) in Publication Number RP-10B.

Cement slurries were prepared in a standard rotational mixer, then conditioned at ambient temperature for 30 min in an atmospheric consistometer. The slurries were then degassed and placed in a water bath. The curing was performed at 60° C. (140° F.) for 72 hours. Cylinders were drilled out of the cement specimens. The dimensions were 1 in. (2.54 cm) diameter and 2 in. (5.08 cm) length. Mechanical properties (compressive strength and Young's modulus) were measured at room temperature and pressure.

### Example 1

Cement slurries were prepared with the following compositions. The slurry composition was 35% by volume of blend (BVOB) Class G cement, 10% BVOB crystalline silica and 55% BVOB flexible particles (either Eltex P HV001PF or Icorene™ 9013P). The slurry porosity was 40% and the slurry density was 12.7 lbm/gal (1520 kg/m³).

Slurry mixability, rheological properties and mechanical properties of the cement systems were measured (Table 2).

TABLE 2
Mixability, rheological properties and mechanical properties
of cement systems containing flexible additives.

| | Eltex P HV001PF | Icorene ™ 9013P |
|---|---|---|
| Slurry Mixability | | |
| Time to observe a vortex @ | 95 s | >300 s |
| 4000 RPM | | |
| Rheological Properties | | |
| (ambient temperature) | | |
| PV (cP) | 152 | 243 |
| Ty (lbf/100 ft²) | 50 | 53 |
| Mechanical Properties | | |
| Compressive strength | 1,790 (12.3) | 2,030 (14.0) |
| [psi (MPa)] | | |
| Young Modulus | 350,000 (2400) | 470,000 (3200) |
| [psi (MPa)] | | |

The slurry mixability was significantly easier when the Eltex material was present, as evidenced by the faster time to observe a vortex in the Waring blender at 4000 RPM. The plastic viscosity (PV) of the slurry containing the Eltex material was lower; however, the yield values (Ty) were essentially the same. The compressive strength and Young's modulus of the set cement containing the Eltex material were lower; however, the values were acceptable in the context of well cementing. Indeed the cement containing the Eltex material was more flexible.

Although various embodiments have been described with respect to enabling disclosures, it is to be understood that this document is not limited to the disclosed embodiments. Variations and modifications that would occur to one of skill in the art upon reading the specification are also within the scope of the disclosure, which is defined in the appended claims.

1. A composition, comprising:
(i) water;
(ii) an inorganic cement; and
(iii) particles with a sphericity between 0.5 and 0.9, and a Krumbein roundness between 0.5 and 0.9.

2. The composition of claim 1, wherein the inorganic cement comprises portland cement, calcium aluminate cement, fly ash, blast furnace slag, lime/silica blends, cement kiln dust, zeolites, geopolymers or chemically bonded phosphate ceramics or combinations thereof.

3. The composition of claim 1, wherein the particles comprise polypropylene, polyethylene, polyisoprene, polybutadiene, polyisobutylene, polyurethane, polyamide, styrene butadiene, styrene divinylbenzene, acrylonitrile-butadiene, acrylonitrile-styrene-butadiene, or polyetheretherketone or combination thereof.

4. The composition of claim 1, wherein the particles are present at a concentration between 5 and 55% of the total volume of the slurry.

5. The composition of claim 1, wherein the particles have an average particle size between 100 microns and 1000 microns.

6. The composition of claim 1, wherein less than 10% of the particles have a size smaller than 100 microns.

7. A method for preparing a cement slurry, comprising:
(i) preparing a mixture comprising water, an inorganic cement and particles with a sphericity between 0.7 and 0.9, and a Krumbein roundness between 0.7 and 0.9; and
(ii) shearing the mixture until the slurry is homogeneous, thereby forming a slurry.

8. The method of claim 7, wherein the inorganic cement comprises portland cement, calcium aluminate cement, fly ash, blast furnace slag, lime/silica blends, cement kiln dust, zeolites, geopolymers or chemically bonded phosphate ceramics or combinations thereof.

9. The method of claim 7, wherein the particles comprise polypropylene, polyethylene, polyisoprene, polybutadiene, polyisobutylene, polyurethane, polyamide, styrene butadiene, styrene divinylbenzene, acrylonitrile-butadiene, acrylonitrile-styrene-butadiene, or polyetheretherketone or combination thereof.

10. The method of claim 7, wherein the particles are present at a concentration between 5 and 55% of the total volume of the slurry.

11. The method of claim 7, wherein the particles have an average particle size between 100 microns and 1000 microns.

12. The method of claim 7, wherein less than 10% of the particles have a size smaller than 100 microns.

13. A method for cementing a subterranean well, comprising:
(i) preparing a composition comprising water, an inorganic cement and particles with a sphericity between 0.7 and 0.9, and a Krumbein roundness between 0.7 and 0.9;
(ii) applying shear until the composition is homogeneous, thereby forming a slurry; and
(iii) placing the slurry in the well.

14. The method of claim 13, wherein the inorganic cement comprises portland cement, calcium aluminate cement, fly ash, blast furnace slag, lime/silica blends, cement kiln dust, zeolites, geopolymers or chemically bonded phosphate ceramics or combinations thereof.

15. The method of claim 13, wherein the particles comprise polypropylene, polyethylene, polyisoprene, polybutadiene, polyisobutylene, polyurethane, polyamide, styrene butadiene, styrene divinylbenzene, acrylonitrile-butadiene, acrylonitrile-styrene-butadiene, or polyetheretherketone or combination thereof.

16. The method of claim 13, wherein the particles are present at a concentration between 5 and 55% of the total volume of the slurry.

17. The method of claim 13, wherein the particles have an average particle size between 100 microns and 1000 microns.

18. The method of claim 13, wherein less than 10% of the particles have a size smaller than 100 microns.

19. The method of claim 13, wherein the slurry has a viscosity lower than 1000 cP at a shear rate of 100 s⁻¹.

20. The method of claim 13, wherein the slurry is placed during a primary cementing operation or a remedial cementing operation.
